(19) United States
(12) Patent Application Publication
(10) Pub. No.: US 2026/0142742 A1
(43) Pub. Date: May 21, 2026

(54) DEVICE FOR DETECTING AND SUPPRESSING UNMANNED AERIAL VEHICLES

(71) Applicant: Aleksandr Sergeevich MOROZOV, Krasnodar (RU)

(72) Inventor: Aleksandr Sergeevich MOROZOV, Krasnodar (RU)

(21) Appl. No.: 19/370,916

(22) Filed: Oct. 28, 2025

(30) Foreign Application Priority Data
Nov. 19, 2024 (RU) 2024134578

(51) Int. Cl. H04K 3/00; F41H 11/02

(52) U.S. Cl. CPC H04K 3/825; F41H 11/02

(57) ABSTRACT

The invention relates to the field of military technology for surveillance and countering unmanned aerial vehicles. A device includes a video signal reception unit, a radio interference generator, a video recorder with a monitor, a control unit and a power supply unit. The control unit is configured to receive data from the video signal reception unit, convert it into a video stream and transmit the data, upon analyzing the video signal, to the radio interference generator to disable the video transmission function of the unmanned aerial vehicle or replace the video signal. The video signal reception unit includes video signal receivers operating independently of each other to cover radio frequency bands of 1.2 GHz, 1.5 GHz, 2.4 GHz, 3.3 GHz and 5.8 GHz, and the radio interference generator is configured to separately cover the radio frequency bands of 1.2 GHz, 1.5 GHz, 2.4 GHz, 3.3 GHz and 5.8 GHz.

### TECHNICAL FIELD

The invention relates to the field of military technology and can be used for surveillance and countering unmanned aerial vehicles (hereinafter referred to as UAVs).

### BACKGROUND OF THE INVENTION

WO/2020/065454 (IPCs: H04K 2203/14, H04K 2203/16, H04K 2203/18, H04K 2203/22, H04K 3/45, H04K 3/65; priority date—27 Sep. 2018; publication date—2 Apr. 2020) discloses a device for detecting and softly jamming an unmanned aerial vehicle, which comprises a set of wireless communication microcircuits, a scanning and detection circuit, a jamming circuit and a controller. The controller is configured to control the scanning and detection circuit to identify the unmanned aerial vehicle, and the controller is further configured to control the jamming circuit to disable the video recording function of the unmanned aerial vehicle without disabling other functions of the unmanned aerial vehicle. The jamming circuit is connected to an antenna, and the antenna is configured to cover at least one of a 2.4 GHz radio frequency band and a 5 GHz radio frequency band.

The disadvantages of the known device are:
inability to view a real-time video stream transmitted from the UAV;
impact on digital UAV control channels (such as DJI, Autel, etc.), which are not very sensitive to the influence of radio interference generators.

U.S. Pat. No. 10,790,925 (IPCs: H04K 3/00, G08B 6/00, G08B 7/06, H01Q 21/22; priority date—12 Jun. 2018; publication date—20 December 2018) discloses a portable countermeasure device having two handles, with the device comprising:
a body including the first handle located at the bottom of the body and the second handle adjacent to the first handle and located at the bottom of the body;
a butt formed on the rear of the body, wherein the first handle is inclined toward the butt of the body and the second handle is inclined at an angle opposite to the first handle toward the front of the body;
a plurality of jamming components located within the body, wherein the jamming components are configured to generate a plurality of jamming signals at a corresponding plurality of related frequency bands;
wherein the device further includes a display component associated with at least one signal interruption component, wherein the display component is configured to visually indicate the activation of the at least one signal interruption component, and wherein the plurality of the related frequency bands correspond to a 72 MHz frequency band, a 400 MHz frequency band, a 800 MHz frequency band, a 900 MHz frequency band, a 1.2 GHz frequency band, a 1.5 GHz frequency band, a 2.4 GHz frequency band, and a 5.8 GHz frequency band. The disadvantages of the known device are:
inability to automatically scan the bands for the presence of UAVs in the air;
inability to view a real-time video stream transmitted from UAVs;
inability to automatically determine the frequency band for countermeasures.

U.S. Pat. No. 10,915,099 (IPCs: G05D 1/00, H04K 3/00, F41H 13/00, B64C 39/02, G01S 3/02, G01S 3/46; priority date—19 Mar. 2019; publication date—9 Feb. 2021) discloses a system for detecting and destroying unmanned aerial vehicles, which comprises:
at least one detection antenna configured to detect a drone control signal within a 360-degree field relative to said at least one detection antenna, wherein said detection antenna is further configured to detect a drone video link;
a neutralization system that is in communication with said at least one detection antenna, wherein the neutralization system includes at least one transmitting antenna tuned to transmit an interception signal to the detected drone and a processing device configured to generate said override signal and control the transmission of said override signal, wherein the processing device is further configured to record a video stream upon detection of said video link. The disadvantage of the known device is the use of a broadband SDR receiver covering the entire radio frequency band from 9 kHz to 300 GHz simultaneously, which significantly slows down the scanning process, as well as the inability to operate simultaneously in several narrow frequency bands.

### SUMMARY OF THE INVENTION

The objective of the claimed invention is to eliminate the above-mentioned drawbacks, and the technical result is an increase in the efficiency of device operation.

The objective and technical result are achieved by the fact that a device for detecting and suppressing unmanned aerial vehicles includes a video signal reception unit, a radio interference generator, a video recorder with a monitor, a control unit and a power supply unit, which are connected to each other. The control unit is configured to receive data from the video signal reception unit, convert it into a video stream that is output to the monitor of the video recorder, and transmit the data, upon analyzing the video signal, to the radio interference generator to disable the video transmission function of the unmanned aerial vehicle or replace the video signal. The video signal reception unit includes video signal receivers operating independently of each other to cover radio frequency bands of 1.2 GHz, 1.5 GHz, 2.4 GHz, 3.3 GHz and 5.8 GHz, and the radio interference generator is configured to separately cover the radio frequency bands of 1.2 GHz, 1.5 GHz, 2.4 GHz, 3.3 GHz and 5.8 GHz.

To control the UAVs, conventional analogue video transmitters comprising cameras and video receivers with monitors or goggles are used, which transmit the video stream transmitted by the UAV to a UAV operator in unencrypted form. By intercepting the video stream transmitted by the UAV, it is possible to visually determine the launch site and flight path of the UAV and, based on this information, ‘blind’ the operator, if necessary. UAV manufacturers use radio frequencies in the 1.2 GHz, 1.5 GHz, 2.4 GHz, 3.3 GHz and 5.8 GHz bands to control them, so it is advisable for the video signal reception unit to cover these radio frequency bands. The use of a separate video receiver for each band in the invention, instead of a broadband SDR receiver covering the entire radio frequency band from 10 MHz to 60 GHz, is due to the fact that scanning one of the above-mentioned bands takes much less time than scanning the entire radio frequency band, and scanning of all the 1.2 GHz, 1.5 GHz, 2.4 GHz, 3.3 GHz and 5.8 GHz bands occurs in parallel and independently of each other. And if one of the receivers fails to operate, the device stops monitoring only one of the bands, which allows the malfunctioning receiver to be replaced without affecting the functioning of the device as a whole. The radio interference generator unit, which is configured to separately cover the radio frequency bands of 1.2 GHz, 1.5 GHz, 2.4 GHz, 3.3 GHz and 5.8 GHz, ensures maximum operating efficiency, as all its power is directed locally to a specific frequency in the band, rather than to the entire band, as is the case with the known devices.

To ensure maximum efficiency, the video signal reception unit uses directional patch antennas which, unlike omnidirectional antennas, have a very high gain coefficient and a very long reception range (25-30 km). It is also possible to mount a directional antenna on a rotating device to automatically point the antenna towards the receiving device in order to achieve maximum signal level and image quality.

To view the video stream with the inverted video signal, the device further comprises a video signal inverter which flips (inverts) the distorted video signal transmitted from the UAV video camera and containing no useful information, whereupon the device operator sees the correct video stream on the monitor of the video recorder.

For remote viewing and control, the device further comprises a communication unit configured to connect to a local network and perform wireless data transmission via Wi-Fi, Bluetooth, GSM, GPRS, Zigbee or a radio channel operating at a different frequency.

The device may further comprises a hard drive for recording the video stream coming to the video recorder.

The device can be installed on a flying carrier both to increase the range of impact and to protect the flying carrier from attack.

### BRIEF DESCRIPTION OF THE DRAWINGS

FIG. 1 shows a block diagram of the claimed device.

### DETAILED DESCRIPTION OF THE INVENTION

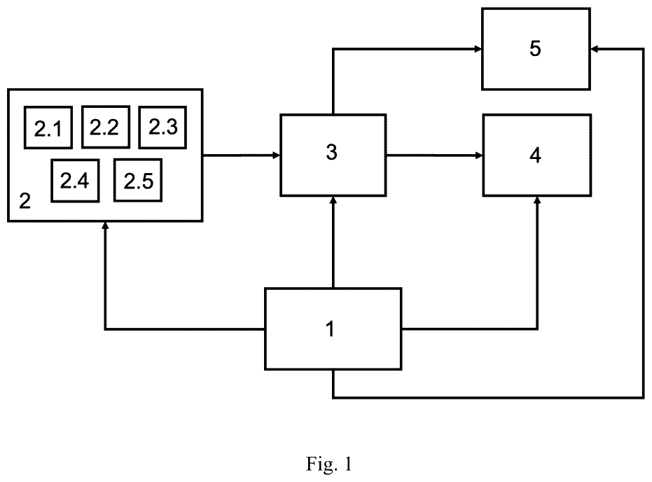

After correct installation and connection to an electrical network, the device (FIG. 1) for detecting and suppressing unmanned aerial vehicles begins to operate after voltage is applied to a power supply unit 1. Video signal receivers 2.1-2.5 independently scan a radio wave spectrum in the 1.2 GHz, 1.5 GHz, 2.4 GHz, 3.3 GHz and 5.8 GHz bands continuously until a video signal level sufficient for reception is detected with synchronization pulses present - signals used to synchronize frames that are specific only to video signals. After detecting a signal with synchronization pulses in one of these bands, scanning in that band stops, while continuing in all others, and the detected signal is sent to a control unit 3.

In the control unit 3 connected to a video signal reception unit 2, the detected signal is converted into a video stream which is displayed to an operator on the monitor of a video recorder 4 with a hard drive for recording and subsequent analysis of the received video stream. In addition, the monitor displays the following information about the device's operation:
search (when there is no signal);
signal frequency and level (when there is a signal).

The device operator visually evaluates the image of the video stream transmitted on the monitor of the video recorder 4 and decides whether to turn on a radio interference generator 5 in the radio frequency band of interest. In this case, the control unit 3 transmits information about the radio frequency band of interest to the radio interference generator 5. Radio interference is a video signal in the form of white noise emitted at the same frequency (in the same channel) at which the video signal with the synchronization pulses is detected in order to ‘blind’ a UAV operator. As a result, the UAV operator sees the white noise instead of the video stream transmitted from the UAV. When the video signal is replaced, the radio interference generator 5 will transmit any other video signal connected to the device, which will be seen by the UAV operator. The radio interference generator 5 is configured to emit radio interference only at that frequency of the band at which the video signal is currently being received, or at any frequency of any of the 1.2 GHz, 1.5 GHz, 2.4 GHz, 3.3 GHz and 5.8 GHz bands with an accuracy of 1 MHz, depending on the decision of the device operator.

The control unit 3 also provides the following functionality: switching on an inverter, switching on the function of maintaining the frequency of interest which provides for the completion of scanning of the frequency band of interest at the moment of UAV detection for further observation only of the detected UAV, especially if the reception quality is uncertain, as well as for monitoring the consequences after exposure to the radio interference generator, re-scanning of the band, radio jamming, and using a digital keypad to enter a specific frequency that is known to require said monitoring and exposure. In addition, the control unit is a power switch for the video signal reception unit.

1. A device for detecting and suppressing unmanned aerial vehicles, comprising:
a video signal reception unit, a radio interference generator, a video recorder with a monitor, a control unit and a power supply unit, which are connected to each other;
wherein the control unit is configured to receive data from the video signal reception unit, convert the data into a video stream that is output to the monitor of the video recorder, and transmit the data, upon analyzing a video signal, to the radio interference generator to disable a video transmission function of the unmanned aerial vehicle or replace the video signal;
wherein the video signal reception unit includes video signal receivers operating independently of each other to cover radio frequency bands of 1.2 GHz, 1.5 GHz, 2.4 GHz, 3.3 GHz and 5.8 GHz, and the radio interference generator is configured to separately cover the radio frequency bands of 1.2 GHz, 1.5 GHz, 2.4 GHz, 3.3 GHz and 5.8 GHz.

2. The device of claim 1, wherein the video signal reception unit comprises directional antennas.

3. The device of claim 2, wherein at least one of the directional antennas is mounted on a rotating device.

4. The device of claim 1, further comprising a video signal inverter.

5. The device of claim 1, further comprising a communication unit configured to connect to a local network and perform wireless data transmission via Wi-Fi, Bluetooth, GSM, GPRS, Zigbee or a radio channel operating at a different frequency.

6. The device of claim 1, further comprising a hard drive.

7. The device of claim 1, wherein the device is installed on a flying carrier.
